(19) United States
(12) Patent Application Publication
(10) Pub. No.: US 2007/0060456 A1
(43) Pub. Date: Mar. 15, 2007

(54) Roll for pressure treatment of material bands

(76) Inventors: Peter Hader, Kempen (DE); Robert Meitner, Krefeld (DE)

Correspondence Address: FRIEDRICH KUEFFNER, 317 MADISON AVENUE, SUITE 910, NEW YORK, NY, 10017, US

(21) Appl. No.: 10/554,716

(22) PCT Filed: Apr. 23, 2004
(86) PCT No.: PCT/EP04/04320

§ 371 Date: Sep. 18, 2006

(30) Foreign Application Priority Data
Apr. 30, 2003 (DE) 103 19 345.6

(51) Int. Cl. B29C 43/46

(52) U.S. Cl. 492/5; 492/6; 492/7

(57) ABSTRACT

The invention relates to a roll for pressure treatment of material bands comprising a carrier (3), a roll sleeve (4) arranged on said carrier (3), and at least one pressure chamber (12) which is disposed between the carrier (3) and the roll sleeve (4), is at least partially filled with liquid and can transmit at least indirectly a hydraulic pressure force from carrier (3) to the roll sleeve (4). According to said invention, the pressure chamber(s) is provided with an elastic element (18′) which unrestrictedly communicates with supporting liquid and is compressible when a liquid pressure required for producing a supporting hydraulic force is exceeded.

The invention relates to a roll for the pressure treatment of material bands of the type corresponding to the precharacterizing clause of claim 1.

Rolls of this type are also referred to as “floating” rolls. They comprise a carrier, usually mounted in a rotationally fixed manner, around which a roll shell forming the circumference of the roll is rotatably mounted. Formed between the roll shell and the carrier is at least one pressure chamber, which is filled with a liquid that can transmit to the roll shell a hydraulic supporting force aligned radially in the direction of the roll nip.

A roll of this type is known from DE-B 1 026 609. To prevent inadmissible pressure increases, it has in the carrier a plurality of blind-hole bores extending from bottom to top, which contain an air cushion above a column of hydraulic fluid.

It is known from WO 88/03610 to provide in the pressure chamber of a floating roll a second chamber, which is connected to the first chamber via a restriction. In the second chamber there is a gas-filled, hermetically closed rubber hose. The second chamber is consequently always only partially filled with liquid. On the basis of this measure, when there is a pressure change in the first chamber, the volume of liquid located in the second chamber can change. Accordingly, vibration of the roll shell leads to an oscillating flow of liquid through the restriction, so that vibrational energy is converted into frictional heat by fluid friction.

DE 31 51 001 A1 relates to a hydrostatically mounted roll, in which the roll shell is supported on the carrier by means of hydrostatic bearing elements. The bearing pockets of the hydrostatic elements are connected to an external, elastically acting pressure accumulator for vibration damping.

Rolls of this type have proven successful for the pressure treatment of material bands, for example for the smoothing and embossing of paper and other materials, the squeezing of moisture from textiles, the calendering and drawing out of films or sheets of plastic and rubber and also for other pressing operations. However, it has been found that, in particular whenever the floating roll is provided with an elastic covering—for example made of plastic—, a polygon forms over the circumference of the covering after an undesirably short operating time. The formation of this polygon is explained by vibrational states in which the roll vibrates against the opposing tool bounding the roll nip—usually a mating roll.

It is therefore the object of the invention to develop a roll of the generic type in such a way that effective vibrational isolation of the roll shell from the carrier is brought about in a structurally simple way, in order to lessen the vibration-induced wear by reducing the mass vibrating against the opposing tool.

This object is achieved by the roll shell specified in claim 1.

The fact that in the at least one pressure chamber there is provided an elastic element which unrestrictedly communicates with the supporting liquid bringing about the hydraulic supporting force and is compressible when the liquid pressure required for producing the hydraulic supporting force is exceeded means that pressure peaks in the roll nip that are caused by vibration of the carrier are at least substantially avoided. The unrestricted communication between the elastic element and the hydraulic fluid has the effect that even vibrations of the carrier of great amplitude are not transmitted to the roll shell, or only slightly.

Tests have shown that, in the case of a floating roll developed according to the invention, the wear to which the covering of the roll shell is subjected is significantly reduced in comparison with those rolls that are formed according to the prior art, and the roll shell can be used for considerably longer before maintenance or renewal.

Apart from the pressure chamber in which the liquid bringing about the hydraulic supporting force is located, the roll may comprise a leakage chamber, which serves for receiving and discharging hydraulic fluid leaving the pressure chamber. At least one further elastic element may then be additionally provided in the leakage chamber to improve the isolation of the roll shell and the carrier.

The at least one elastic element preferably has a hollow chamber which is, or can be, provided with a compressible medium.

In the case of a preferred structural variant, the elastic element is formed as a hose.

The compressible medium is preferably air.

In the case of a first possible embodiment, the elastic element is formed in a closed manner and filled with a predetermined pressure. This pressure is then below the lowest pressure exerted on the hydraulic supporting liquid. During use of the roll, the elastic element is then compressed to such an extent that an equilibrium is established between the pressure of the supporting liquid and the pneumatic pressure in the elastic element.

Tests have shown that filling the elastic element with atmospheric pressure is suitable for many applications.

However, to extend the pressure range for which the roll according to the invention can be used, it is preferred if the elastic element comprises a one-way valve, by means of which it can be filled with air under a pressure that is in turn lower than the pressure exerted on the hydraulic supporting liquid during operation of the roll. The pressure in the elastic element can then be optimally adapted to the pressure conditions respectively to be expected in the pressure chamber and, if applicable, the leakage chamber.

One disadvantage of the embodiment of the roll according to the invention with a closed elastic element is that the latter must have the largest possible internal volume in order for the roll to be suitable for the largest possible pressure range in the roll nip. This is so because, only with a minimum starting volume is it ensured that even under the highest, desired operating pressure the air volume has an adequate air volume to compensate for vibrations of the carrier. However, a large starting volume of the elastic element requires a correspondingly large free space in the pressure chamber or leakage chamber, which leads to an undesired weakening of the carrier and an accompanying increase in the tendency to vibrate or enlargement of the vibration amplitude.

Particularly preferred therefore is an embodiment of the roll according to the invention in which the at least one elastic element is connected to a compressed air source, by means of which the pressure can be adjusted in such a way that it is always slightly higher than the pressure exerted on the hydraulic supporting liquid. In the case of this embodiment, in other words, the pneumatic pressure in the elastic element—i.e. its compliance—is adapted to the respectively current hydraulic pressure that is being exerted on the supporting liquid.

To prevent the elastic elements from collapsing, they may be equipped with means for internal support, for example a spiral coil of an elastically deformable material.

To accommodate the at least one elastic element, a recess machined into the carrier is preferably provided. In particular whenever the elastic elements are formed as hoses, it preferably has the form of an axially parallel running longitudinal groove.

Particularly preferred is an embodiment of the roll according to the invention which comprises means for determining the hydraulic pressure exerted on the supporting liquid. These means may comprise a pressure sensor, which is preferably arranged outside the roll but fluidically communicates with the pressure chamber.

In the case of a particularly preferred embodiment of the roll according to the invention, the pressure sensor serves for controlling or regulating the pneumatic pressure to which the at least one elastic element is subjected.

An exemplary embodiment of the roll according to the invention is—schematically—represented in the drawing, in which:

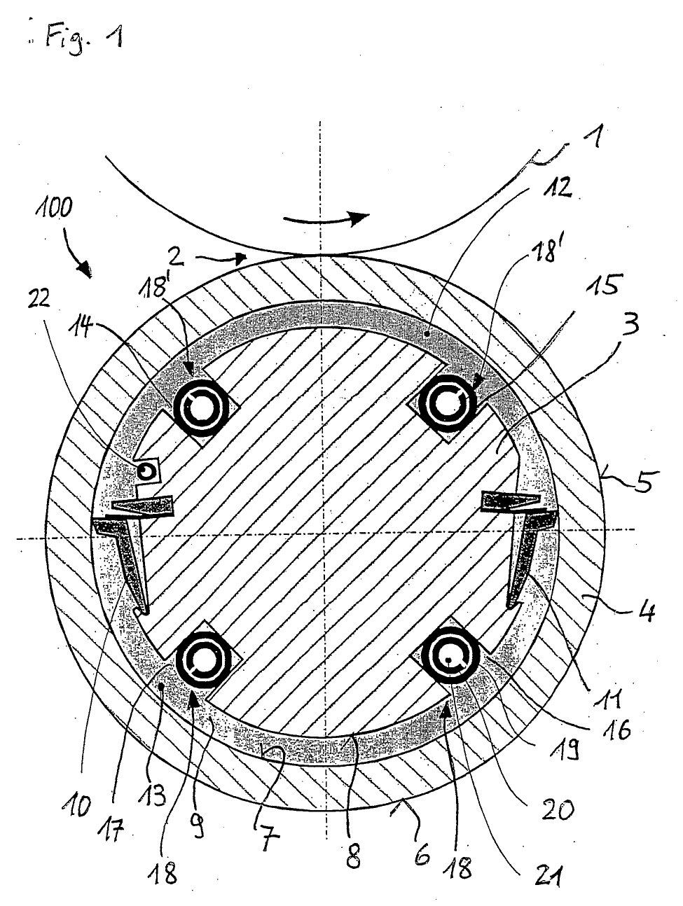

FIG. 1 shows the roll in a cross section;

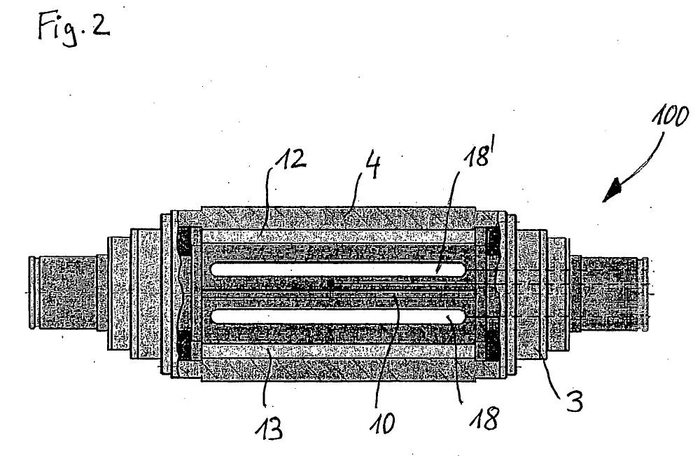

FIG. 2 shows the same roll in a partly sectioned longitudinal view and

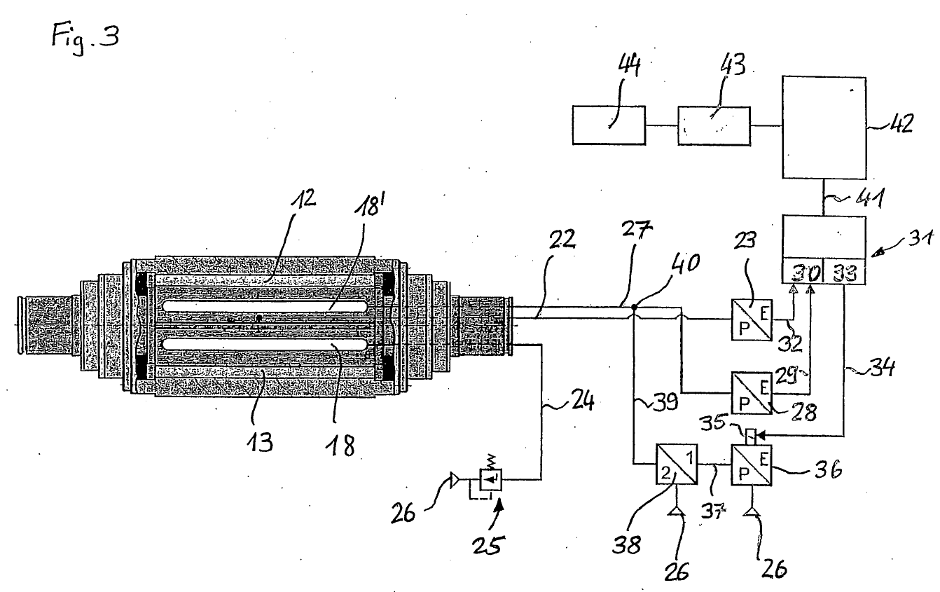

FIG. 3 shows the hydraulic and pneumatic connections of this roll.

The roll, designated as a whole by 100, is designed as a so-called floating roll. With an opposing roll 1, it forms a roll nip 2 for the pressure treatment of a continuously advancing material band (not represented in the drawing). The opposing roll 1 may be designed as a conventional roll, as a deflection-controlled roll, as a floating roll or in any other way desired.

The roll 100 according to the invention comprises a carrier 3, which is mounted in a rotationally fixed manner on a machine frame (not represented in the drawing). Mounted rotatably around the carrier 3 is a roll shell 4, the outer lateral surface 5 of which forms the working circumference 6 of the roll 100.

Between the inner lateral surface 7 of the roll shell 4 and the outer lateral surface 8 of the carrier 3 there is an annular gap 9, which is subdivided by two mutually opposite longitudinal sealing arrangements 10, 11 into a pressure chamber 12, facing toward the opposing roller 1, and a leakage chamber 13, facing away from the opposing roller 1.

During the operation of the roll 100, the pressure chamber 12 contains supporting liquid under a hydraulic pressure, the pressure of which determines the linear force prevailing in the roll nip 2.

The leakage chamber 13 serves for receiving and discharging supporting liquid, which gets into the leakage chamber past the longitudinal sealing arrangements 10, 11.

Machined into the carrier 3, distributed over its circumference, are longitudinal grooves 14, 15, 16, 17, which serve for respectively accommodating an elastic element 18, 18′, which unrestrictedly communicates with the supporting liquid and the construction and operating principle of which are to be further described below.

The elastic elements 18, 18′ are formed as hoses. They respectively comprise an outer sheath 19 of an elastic material and supporting means 20, which are arranged in the internal volume of the outer sheath 19 and prevent the outer sheath 19 from collapsing even under relatively high pressures of the hydraulic supporting means.

In the internal volume 21 of an elastic element 18, 18′ there prevails a pneumatic pressure, the level of which is regulated in a way described further below on the basis of FIG. 3 in dependence on the level of the hydraulic pressure exerted on the supporting liquid. To determine the hydraulic pressure currently prevailing in the pressure chamber 12, a measuring line 22 is provided, connecting the pressure chamber 12 to a pressure/electrical converter 23 positioned outside the roll 100 (see FIG. 3).

The hydraulic and pneumatic connections of the roll 100 according to the invention are now to be described on the basis of FIG. 3.

The elastic elements 18 communicating with the leakage chamber 13 and represented at the bottom of FIG. 1 are connected to a central compressed air source 26 via a pneumatic line 24 and a pressure reducer 25. It goes without saying that, instead of a single pneumatic line 24, which is then connected to the elastic elements located in the leakage chamber 13 via a distributor (not represented in the drawing), separate pneumatic lines for one of the elastic elements in each case may also be provided.

The pressure reducer 25 regulates the pressure to a value which is less than 1/10 bar higher than the hydraulic pressure exerted on the hydraulic supporting medium in the leakage chamber 13, which has an outflow (not represented in the drawing). The pneumatic pressure in the pneumatic line 24 is typically about 0.3 bar; the hydraulic pressure in the leakage chamber 13 is typically 0.1 bar.

The elastic elements 18′ communicating with the pressure chamber 12 are connected via a collective line 27 or—alternatively—via individual lines to a pressure/electrical converter 28, which converts the pneumatic pressure prevailing in the internal volume 21 of the elastic elements into an electrical signal. The latter is fed via an electrical line 29 to an input 30 of a control unit designated as a whole by 31. Furthermore, the electrical signal generated by the pressure/electrical converter 23, which is a measure of the level of the hydraulic pressure of the supporting liquid, is fed to the input 30 via an electrical line 32.

The control unit 31 compares the two input signals and produces at its output 33 an output signal which is dependent on the difference between the input signals and is fed via an electrical line 34 to the actuating element 35 of a pneumatic pressure regulator 36.

In dependence on the electrical signal, the pressure regulator 36 regulates the pneumatic pressure exerted by the external compressed air source 26, which is typically 6 bar, to a value between 0 and 5 bar, which is exerted on a pneumatic line 37 connected to it. Since in the pressure chamber 12 there may also be pressures of over 5 bar, sometimes up to 10 bar, the pneumatic line 37 is connected to the input of a pressure doubler 38. Its output, at which double the pressure that prevails in the pneumatic line 37 is present, is connected to a pneumatic line 39, which for its part, opens out into the collective line 27 at the point 40.

The control unit 31 is connected via a data line 41 to a monitoring unit 42, which analyzes and indicates the respective operating state of the control unit 31 and can be remotely actuated by means of an operator control unit 44 connected via a modem 43.

### LIST OF REFERENCE NUMERALS

1 Opposing roller
2 Roll nip
3 Carrier
4 Roll shell
5 Lateral surface
6 Working circumference
7 Lateral surface
8 Lateral surface
9 Annular gap
10 Longitudinal sealing arrangement
11 Longitudinal sealing arrangement
12 Pressure chamber
13 Leakage chamber
14 Longitudinal groove
15 Longitudinal groove
16 Longitudinal groove
17 Longitudinal groove
18 Elastic element
19 Outer sheath
20 Supporting means
21 Internal volume
22 Measuring line
23 Pressure/electrical converter
24 Pneumatic line
25 Pressure reducer
26 Compressed air source
27 Collective line
28 Pressure/electrical converter
29 Electrical line
30 Input
31 Control unit
32 Electrical line
33 Output
34 Electrical line
35 Actuating element
36 Pressure regulator
37 Pneumatic line
38 Pressure doubler
39 Pneumatic line
40 Point
41 Data line
42 Monitoring unit
43 Modem
44 Operator control unit
100 Roll

1. A roll (100) for pressure treatment of material bands,
with a carrier (3),
with a roll shell (4) mounted around the carrier (3),
with at least one pressure chamber (12) between the carrier (3) and the roll shell (4), which chamber is filled at least partly with a supporting liquid which can transmit the hydraulic supporting force from the carrier (3) to the roll shell (4), at least indirectly
wherein in the at least one pressure chamber (12) there is provided an elastic element (18′) which unrestrictedly communicates with the liquid and is compressible when the liquid pressure required for producing the hydraulic supporting force is exceeded.

2. The roll as claimed in claim 1, wherein the roll comprises at least one leakage chamber (13) for receiving supporting liquid leaving the pressure chamber (12).

3. The roll as claimed in claim 2, wherein at least one elastic element (18) is provided in the at least one leakage chamber (13).

4. The roll as claimed in claim 1, wherein the at least one elastic element (18, 18′) comprises a hollow chamber which is, or can be, provided with a compressible medium.

5. The roll as claimed in claim 4, wherein the at least one elastic element (18, 18′) is formed as a hose.

6. The roll as claimed claim 4, wherein the compressible medium is air.

7. The roll as claimed in claim 6, wherein the elastic element (18, 18′) is closed and filled with a predetermined pressures.

8. The roll as claimed in claim 7, wherein the elastic element 18, 18′) is subjected to air under atmospheric pressure.

9. The roll as claimed in claim 7, wherein the elastic element (18, 18′) comprises a one-way valve, by means of which it can be filled with air under a pressure that is lower than the pressure exerted on the hydraulic supporting liquid during operation.

10. The roll as claimed in claim 6, wherein the at least one elastic element (18, 18′) is connected to a compressed air source (26), by means of which the pressure can be adjusted in such a way that it is always slightly higher than the pressure exerted on the hydraulic supporting liquid.

11. The roll as claimed in claim 5, wherein the elastic elements (18, 18′) formed as hoses comprise means for internal support (20).

12. The roll as claimed in claim 10, wherein the means for internal support (20) comprise a spiral coil of an elastically deformable material.

13. The roll as claimed in claim 1, wherein the at least one elastic element (18, 18′) is provided in a recess machined into the carrier (3).

14. The roll as claimed in claim 13, wherein the recess has the form of an axially parallel running longitudinal groove (14, 15, 16, 17).

15. The roll as claimed in claim 1, wherein the means for determining the hydraulic pressure exerted on the supporting liquid are provided.

16. The roll as claimed in claim 15, wherein the roll is designed in such a way that the means for determining the hydraulic pressure serve for controlling or regulating the pneumatic pressure to which the at least one elastic element (18, 18′) is subjected.
